(19) United States
(12) Patent Application Publication
(10) Pub. No.: US 2017/0255605 A1
(43) Pub. Date: Sep. 7, 2017

(54) Annotations and Issue Tracking for Graphical Data

(71) Applicants: Leon J. Kehl, Floradale (CA); Kevin T. Martin, Richmond, VA (US); Geoffrey E. Vanderkooy, Waterloo (CA)

(72) Inventors: Leon J. Kehl, Floradale (CA); Kevin T. Martin, Richmond, VA (US); Geoffrey E. Vanderkooy, Waterloo (CA)

(73) Assignee: Power TakeOff Inc., Boulder, CO (US)

(21) Appl. No.: 15/442,776

(22) Filed: Feb. 27, 2017

Related U.S. Application Data
(60) Provisional application No. 62/303,441, filed on Mar. 4, 2016.

(51) Int. Cl. G06F 17/24; G06T 11/20

(52) U.S. Cl. CPC G06F 17/241; G06T 11/206

(57) ABSTRACT

A system is described that directly associates issue tracker functionality via an annotation, and a graphical representation of a set of data points. This system may be applied to collaborative workflow processes including issue tracking.

### FIELD OF THE INVENTION

The present invention relates generally to annotations, workflow and issue tracking as applied to graphical or chart data.

### BACKGROUND

### Graphical Data and Annotations

A table or tables of data can be viewed in tabular form, or graphically as a graph or chart. Though tables may be more exact, graphical interpretations may allow the existence of events or artifacts of interest to be seen much more easily by a person. For tabular data, a graphic view on a computer, combined with the ability to zoom in and out on a data set is so superior to a table view that the table view may never be used. A computer with graphical zoom abilities also allows exploration of very large data sets.

Notes regarding data are often written directly on top of or to the side of a physical printout of a table or graph. However, if the data is stored in a computer, adding notes may not be supported by the application program. Associating a note with a particular data point or range may be impossible within the program. Users will have to keep track of their work related to specific data separately. For a common spreadsheet program like Microsoft Excel, comments can be added to specific cells of data, but they cannot be practically associated with the graphical view of the data. The best a user can do is to draw an arrow or symbol on top of the graph pointing to issues of interest. Any changing of the data, for example lengthening or shortening the data set, or changing of the graph, for example zooming in or out, will disconnect the symbols from the data point or points they were trying to indicate.

Comments of graphical information is described in a plurality of disclosures including U.S. Pat. No. 8,661,358 and U.S. Pat. No. 8,271,892 that describe the sharing of interactive charts. However, such systems do not provide the ability to capture the workflow associated with graphical data or additional attributes of a graphical representation when an annotation is made.

### The Need for Annotations of Graphical Data

For example, when looking at energy usage data, there can be observations such as how the energy ramp up at the start of the facility's operations is particularly excessive on specific days, or how there are large energy usage spikes when specific equipment is turned on, or high energy usage when a plant should not be under operation.

These observations will be recorded separately and possibly shared with other people. This sharing may be done in an ad hoc way such as email. The user will have to note the data and time of the observation, and what data should be viewed together in regard to the specific observation. Alternatively, a more structured collaboration system may be used. An example of such a collaboration system is disclosed in U.S. Pat. No. 8,595,629. Although that disclosure provides advantages over an ad hoc system it suffers from the disadvantage of no direct association between the graphical data itself and the user's annotation. The observation can thus be separated from the context of the graphical data.

In another example, if there is an anomalous reading in data, it could be noted and sent to the data collection manager for remedy. Being able to see the data in the same way that the original reporter sees it could be extremely useful.

In another example, a sensor is moved or otherwise changed. The change event would ideally be recorded directly on or with the data stream.

In another example, the user undertakes a particular energy saving measure at a moment in time and ideally records the action directly on the data stream. This would help explain why data that follows may be qualitatively or quantitatively different.

In another example, the user responds to an alert of high energy usage from the system by taking a specific set of actions. Both the alert and subsequent action would ideally be recorded with the corresponding data stream.

In another example, the facility has a unique event, such as being a venue for a Saturday evening public lecture when there is typically no common weekend evening operations at the facility. This unique energy usage event that was intentional but would not be consistent with past energy usage patterns would ideally be recorded directly on or with the relevant data stream.

Misunderstandings in the communication of observations can result in people looking at what they believe to be the same data but not seeing the expected issue because of a small communication error or omission causing them to be looking at different contexts. A similar misunderstanding can occur with an individual reviewing their own historical notes because the context or correct view of the data is not preserved.

Similarly, once an issue has been identified and noted, this may start a chain of actions in response to the issue. For example, for data problems, the data manager may start communicating with collectors to determine how the issue occurred and how to correct it. For a usage spike, various stake holders may be contacted to see if between them they can determine the actual source of the spike. There are issue trackers that exist, especially for software bugs and customer issues, but they rely on being able to input all the relevant information into the tracker system, thus separating it from the data.

### Issue Trackers

Another prior art that is relevant to this invention is the issue tracker. At its simplest, an issue tracker is just a list of text note issues. Issue trackers have been expanded over the years to include different types of media recorded with the issue like images and table, followers who receive notifications of updates, workflow aspects like state (status) and assignees (roles), planning aspects like priorities and milestones, discussion forums, history tracking, effort tracking, grouping and associating issues (tags, stories and epics), and estimates and metrics.

Issue trackers are regularly used in software development environments to track features and bugs, customer service departments to track customer service issues, sales and marketing departments to track customer communications using Customer Relationship Management (CRM) systems and others. An example issue tracker patent is U.S. Pat. No. 6,222,535 which describes an issue tracking system that utilizes a set of graphical user interfaces. These systems have utility but do not provide the ability to directly annotate graphical data.

### SUMMARY OF THE INVENTION

An issue tracker system that is associated with graphical data. In the simplest embodiment it allows a text annotation to be associated with a single data element or range of elements of a graph or chart.

For display purposes, an indicator artifact such as a symbol or icon could be shown on the graph at a position close to the associated data point. For a range of data, indicators could be shown near both end-points of the range. Similarly, the indicator could be more like a line or bar that crosses the entire range associated with a note corresponding to a range of data. When viewing data and the range is larger than the viewable data on the graph or chart, then indicators could show that the range continues off one or both sides of the graph or chart.

Hovering over or clicking an indicator could select the note or show other aspects of the note. Clicking on an indicator could also open a screen showing the full text details of the note. Similarly, there could be a details panel visible so when a note is selected or chosen, the details of the note are displayed in the details panel. These indicators allow anyone looking at the data to be able to see that there are notes associated with the data, that they can easily access and review.

The state or look of the graph or chart could also be associated with the note. The state or look of the graph when the note is created is part of the context of the note, and therefore can be associated and stored with the note. This includes other data that may be co-displayed at the time, as well the actual display of the data series that includes the chosen range of interest. This can include, but is not limited to, the range display, scales, patterns and colors of the graphical display. In a specific example for the energy industry, the main data series could be specific electricity variables such as energy usage (kWh), voltage, current, kVar, power factor, or harmonics. Co-displayed data could include temperature and humidity data, occupancy or production data, light sensor data, and motion sensor data.

When viewing a note, the user should be able to view the graph or chart as the note was when it was created if desired. This could be a panel that displays the graph or chart associated with the note, or the ability to display a graph or chart in the original format optionally with the note indicated by an indicator. This ensures that context that may be required to understand the note is as intended. It also creates a foolproof way to show the data in a way that was intended at another time or for another person.

In another embodiment, the note body may include rich-text features such as images, table, sound or video recordings and links to external systems. This allows for more flexible comments and observations.

In another embodiment, the notes can have tags associated with them. This will allow notes to be arbitrarily grouped and will aid in searching for specific notes.

In another embodiment, the indicator shown on the graph or chart may be related to or determined by the tags chosen for the note. This allows for quick visual recognition of the type of note associated with the data.

In another embodiment, a note can have a status or workflow associated with it. An example of a simple workflow or list of states could be Needs Attention, Under Investigation, Done and No Action. The workflow options could be defined by the user. This allows for proper follow-up on annotations that require a response or drive action.

In another embodiment, the indicator shown on the graph or chart may be related to or determined by the state or status of the annotation. This allows for quick visual recognition of the state of notes associated with data. In a more general sense, the indicator could be related to any attribute or set of attributes of the annotation. This would allow quick visual recognition of annotations based of what was deemed important by the user or application.

In another embodiment, followers or notifications can be associated with a note. Anyone who is listed as a follower of a note could be notified when certain events occur for the note. For example, followers could be alerted via e-mail or other means whenever a note is changed, or maybe only if the state of a note is changed. The criteria to determine if a follower is notified could be global or set for the specific note or for the specific follower. This allows automatic information sharing for people who should know about the issue.

Similarly, roles and responsibilities could be associated with a note. The person who is responsible for the note could be identified and changed over time. The original creator of the note could be identified. This could help communicate and indicate clearly who is responsible or should be or involved with an issue.

In another embodiment, users can add updates or messages to the note text. This would facilitate a discussion between people relevant to the note.

In another embodiment, notes can be searched or filtered by any subset of their attributes. This will aid in finding issues that need attention or to reference historical events.

In another embodiment, notes can have an associated address or Universal Resource Locator (URL). Then they can be referred to from outside the system, in an e-mail or report for example, but using the address the user can go directly to the note and its graphical context.

In another embodiment, all other aspects of issue tracking systems could be associated with a graphical annotation.

### BRIEF DESCRIPTION OF THE DRAWINGS

The present invention is illustrated by way of example, and not by way of limitation, in the figures of the accompanying drawings. Other features and advantages of the invention will be apparent from the following drawings, taken together with the description of the invention, in which:

FIG. 1 is a general architectural description of the key parts of a computer required to support the invention.;

FIG. 2 is an example line chart showing a graphical view of embodiment of an interface of the invention;

FIG. 3 is an example text view of an annotation in one possible embodiment of the invention;

FIG. 4 is a flowchart show annotation creation in an embodiment of the invention;

FIG. 5 is a flowchart showing example possible ways that a user could navigate to an annotation in an embodiment of the invention.

### DETAILED DESCRIPTION OF THE INVENTION

The present invention generally relates to computerized graphical display of numerical data, and specifically to adding aspects of issue tracking systems to specific data in a graphical display.

The graphical data could be any numerical data. Example uses include energy usage or generation data, meteorological data, and financial data. For the energy usage data example, an energy analyst or building manager could be looking through the data to optimize energy usage. This could involve identifying anomalous usage such as high energy when a plant is nominally not operating, or identifying peak demand periods. For financial data, the information could be exchange rates and identifying related events that caused movement in the rates.

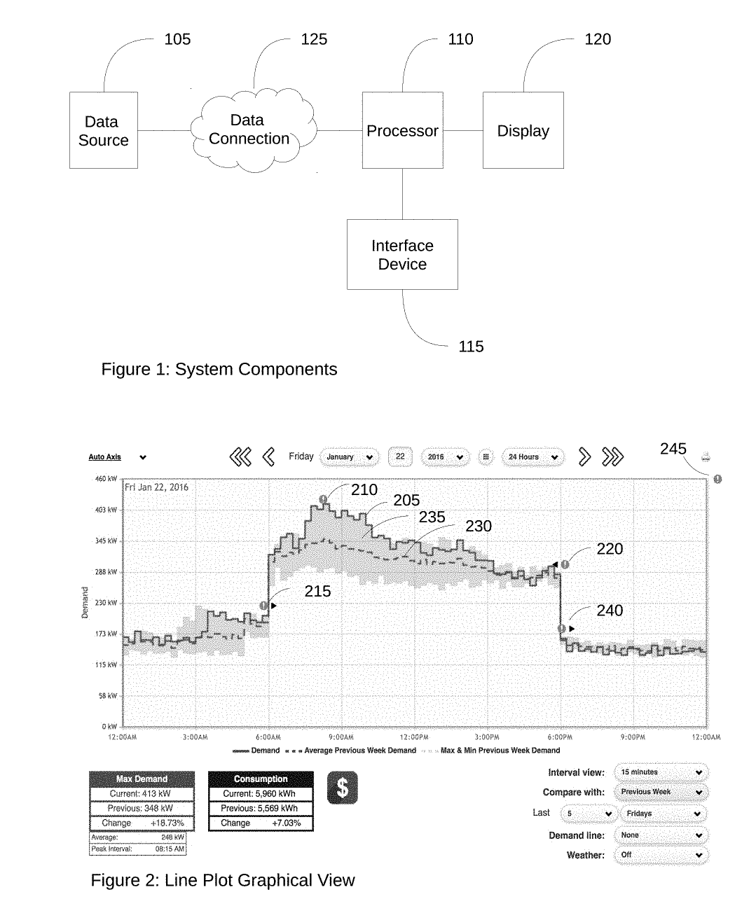

FIG. 1 illustrates one embodiment of the main hardware components to support the annotation system. A processor 110 is needed to run an application to manage and manipulate the numerical data, as well as a display 120 to graphically display the data. The display could be a typical monitor, but could include any type of display including immersive virtual reality displays. The system would also need one or more interface devices 115 to allow the user to interact with the system. These would currently most commonly be items like keyboards, mice, touch screens, but could be any interface device including drawing tablets, voice controllers and haptic interfaces. The system would also need a data source 105 to store the data and from which the processor 110 could retrieve it. This could be part of the computer system, or it could be remote on a different computer or server via a communication method such as an internal network or the internet. These different possible connections from the processor 110 to the data source 105 is seen as element 125. Similarly, the data and annotation could be available to one or more users, depending on the design of the application.

For a web based or distributed application, the processor 110 may actually be many processors at different locations. For example, one processor involved in the invention could be on a server, and another process could be on a local computer.

The display 120 could display graphical data in any way that is appropriate for the data. Common displays would be bar charts, line plots and scatter plots, but it could include more infrequent display types like pie charts, surface plots, radar diagrams and node diagrams. The system would typically provide the capability to zoom in and out of a particular graphical representation as appropriate, as well as overlay multiple data sets for comparisons. This allows for easy management of large data sets. The application may optionally have search or filtering abilities to look for particular data relationships. For example, the ability to search for a value rise or drop of more than a set amount over a limited period or time, or for breaks in the data.

This invention allows for the association of issue tracker functionality with an element or range of data on a graph via an annotation. There are two views of the annotation. One is the graphical view where there is likely an indicator on a graph showing where the annotation is located. This view is important because it lets the annotation be seen in a graphical display, and likely shows the graphical context of other data, both the surrounding data from the data series itself, but also with any other data series that are displayed with it. The second view is a text view. This view can show any textual or other content associated with the annotation.

FIG. 2 shows an example line plot graphical view. Data set 205 has an indicator 210 of a point annotation and indicators 215 and 220 of a range annotation. In this example, range indicators have an accompanying arrow to indicate they are associated with ranges and which direction the range extends. Additionally, annotation indicators could be different for many annotations to help distinguish them. Another range annotation is shown by indicators 240 and 245. This range indicates that it continues off the side of the graph.

Another data set 230 is shown with a dashed line for comparison to the main data set 205. Similarly, a data set 235 showing a range of values for comparison to the main data set 205 is also shown. These additional data sets 230 and 235 give additional context. The state and arrangement of the graph and the other data sets could be associated and stored with the annotation if this additional context is useful for users.

A text box showing a summary of the annotation that could appear if requested by the user. This could be accomplished by clicking or hovering over the icon indicator for example, or any other user interface option that would fit in the context of the system.

There are many aspects of issue trackers that could be relevant for graphical data. The most likely common ones are given here.

Annotations are likely to have a name or title. This gives them a quick description to help understand the entire annotation. Similarly, annotations will often have a reference number, which is typically unique, though this may or may not be exposed to the user. This makes a simple referencing system to issues. Alternately, an issue could have a direct address or URL to allow external references to point to an issue.

Longer descriptions are common features of issue tickets. They can give any user a better understanding of the issue. These can be rich-text fields that accept different types of entry including any computer object like images, drawings, charts, and links. Going more generally, an issue could have any computer representable attachment added to it. If users can post messages to the issue, which can just be additional description, then a conversation and progress can be recorded, forming part of the issue's history.

History can also be part of the workflow of an issue, helping guide and track an issue from identification to resolution. Other issue tracker aspects help issue workflow. For example, tags can be used to group or organize issues. Tags can be predefined or user defined labels that can be applied to any issue. Often multiple tags can be applied to issues. There could be sets of tags. One set of tags could be for the issue type. This could separate issues between automatically generated system issues and manually created user issues for example. Another workflow element is issue state or status. This can help users understand where an issue is in its lifecycle and what the next logical step is. Possible state could be predefined by the computer application or settable by a user. A simple set of workflow states could be No Action, Needs Attention, Under Investigation and Done. To help focus user efforts appropriately, issues could also have an associated priority. Users can to identified as associated with an issue, defining their roles or responsibility for the issue. The most common role would be someone who is to receive notifications of changes to an issue. These are sometimes referred to as followers of an issue. Notification can be for all changes or only for specific changes. The other most common role is to be the Assignee, the person currently responsible for working on the issue.

Issue history can also involve things like recording the creator, the times of events and status changes, and even the effort or costs accrued by the issue.

Some systems will have benefit from being able to set the visibility of an issue. For example, consultants could be commenting on data to themselves, but only have specific issues that they share with others.

Depending on the complexity of an issue or relation to other things or systems, the ability to associate external references with an issue may also be useful. This could link an issue to external research for example.

Note that annotation indicators can be chosen to reflect any set of attributes. For example attributes can simply be a point or range type symbol, or all unique, or represent the state of the annotation, or the assignee of an issue. They could also represent combined attributes. These would help viewers quickly understand key aspects of an issue, even from the graphical display. Many issue trackers associate icons with an issue, but it is usually displayed in an issue list.

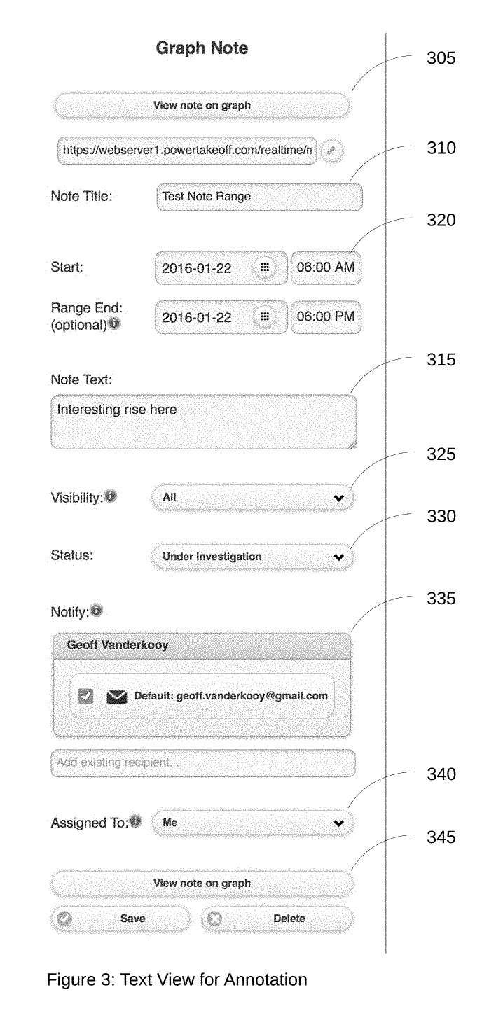

FIG. 3 shows a text view for an example annotation. A shareable URL link 305 is shown that could be copied and shared with others to direct them to the note. A title 310 and description 315 are shown to describe the purpose and description of the note. The associated index 320 indicates if the note is for a point or a range. In this example, the index is by date and time, but it could be by whatever values index the data, including index number. The user can indicate the allowed visibility 325 to other users of the system. This could make notes private, or shared with specific groups of other users, or all users for example. These group options could be defined by either the application, an administrator or the user. The status 330 indicates the state of the workflow of the annotation. The workflow states could be defined by the system, administrators or users. A simple set of states could be No Action, Needs Attention, Under Investigation, and Done. More complicated workflows could exist if appropriate. Notifications 335 shows who will be notified of changes to the annotation. This could be any number of users, including no users. Notifications could be done by e-mail, in-system messaging, text messaging or any other communication method that can be initiated by the application. The Assigned To field 340 indicates who is currently responsible for the note—another aspect of workflow. The “View note on Graph” button 345 allows the user to bring up the graph view in the same state as when the note was created. This includes any other data sets, the range of the axes, colors of the data, display type, and all other aspects of the graphical view. Though not shown, other aspects of ticketing system could be included such as a log of comments or messages against the note, attachments, time estimates, links to related tickets or information, priorities, tags, deadline or goal dates, or history. By including any or all of the aspects of a ticketing system, the actions, history and data are closely associated.

The graphical view and the text view could be separate windows that the user changes between or can view simultaneously.

Traditional issue trackers have alternate views of tickets. For example there can be card wall view which shows tickets grouped by state or status. There are also planner views. These and other ticket views can also be built into the software if deemed useful for the application.

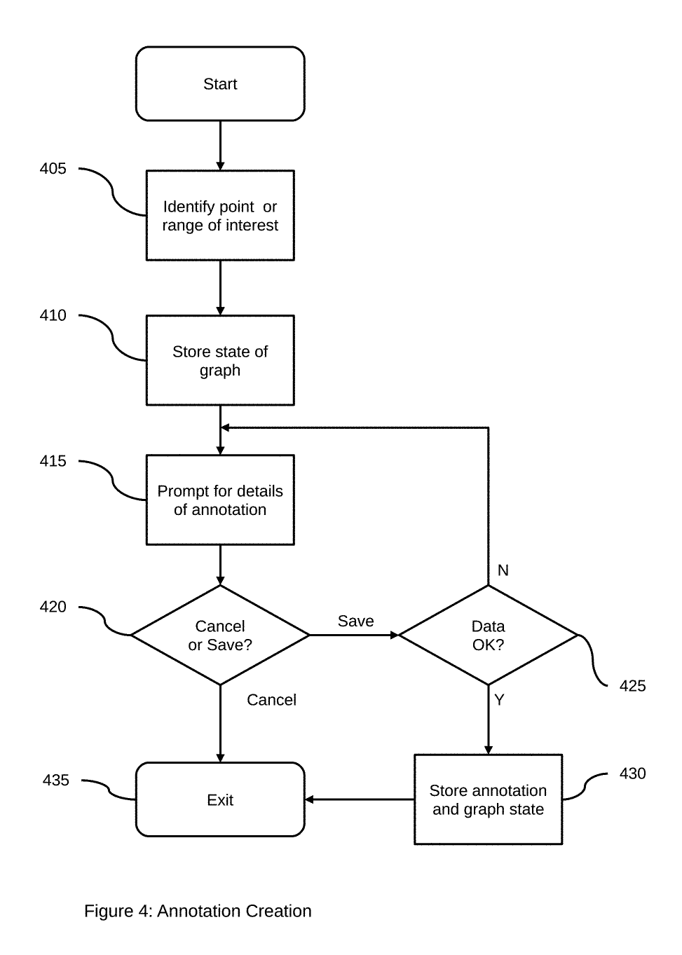

FIG. 4 provides a flow chart that describes the process of a single annotation generation on a graph using the computer system of FIG. 1. A user, which could be an individual or a collaborating group, identifies an item on the display 120 which is a point or range of interest 405 to annotate. Once the user has indicated to the system that they wish to create an annotation, the system then captures the state of the displayed graph 410. The state includes, but is not limited to, the axes ranges, data set(s) present, the type of graph, and characteristics of the graph such as color, line style, and line weight as well as the time that the annotation was made. The user is then prompted for details of the annotation 415. The system may optionally enforce minimum information requirements on the user and may optionally facilitate user input through default values, drop-down menus or other mechanisms. When the user or system determines that the detail input is complete, through a timeout or some other mechanism, the user may be given the choice to save or cancel the annotation 420. If the choice to cancel is made the process terminates 435. Otherwise the system checks whether the detail data is sufficient 425 for the particular embodiment and, if not, the system re-prompts the user for details of the annotation 415. If the input from the user is sufficient the details of annotation and the graph state is stored 430 and the single annotation generation process is completed.

The annotation could be stored in the data source 105 with the source data, or in any other data storage as long as the annotation can be associated with data set.

Note that the process of FIG. 4 may be repeated as needed to capture multiple annotations. A single data point may have multiple annotations associated with it.

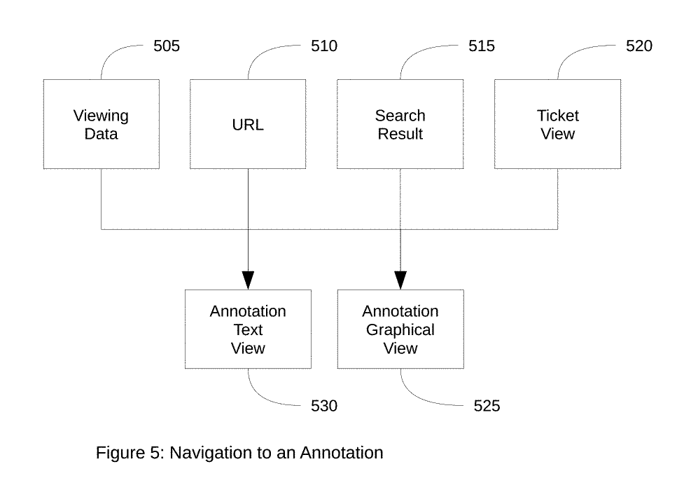

FIG. 5 shows the many ways that a user may navigate to an annotation. The user may be simply viewing the data 505 and come across the indicator on the graph indicating an annotation. Depending on the options provided by the application, the user could proceed to view the text annotation 530, or to the full graphical view of the annotation 525 optionally with the original graphical state and context of the annotation. Alternately the user could have a URL 510 associated with an annotation. By following the URL the user could arrive at either the annotation text view 530 or the annotation graphical view 525 or both depending on which the specific URL referred to. In addition, the user could do a search for annotations that meet certain criteria. From the result list generated by the search the user could be able to go to either the annotation text view 530 or the annotation graphical view 525 or both. Similarly, any ticket view 520 could list a ticket which could be followed to any of the annotation text view 530 or the annotation graphical view 525 or both.

It should be possible for annotation search or filter capabilities to be provided by an application based upon almost any attributes of the annotations in the system. For example, a user may be able to search by the assignee. This would allow the user to find all the annotations assigned to themself for example. Similarly, the user may be able to search for annotations based upon the state or status of the annotation. This could allow the user to search for all the annotations that have not been dealt with yet. There is clearly benefit from being able to search based upon combined attributes. Combining the previous two examples, the user could search for annotations assigned to themself that have not been dealt with yet. Filtering could be used to control which annotations will be displayed in graphical displays.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### CONCLUSIONS, RAMIFICATIONS, SCOPE

Thus the reader will see that at least one embodiment of the disclosed system that describes a system that directly associates an annotation with a graphical representation of data provides distinct advantages over current solutions by facilitating analysis and understanding by one or more observers of graphical data.

The system makes collaboration more effective and strengthens the utility of existing issue tracking systems and graphical data displays.

What is claimed is:

1. A computer system which directly associates an annotation and a graphical representation of a set of data points comprising:
1. a data source of graphical information
2. a computing system that provides the ability to view said graphical information and input annotation information related to said graphical information
3. memory to store said annotation information
4. a program set that can associate said graphical information with said annotation information
5. any aspects of an issue tracking system.

2. The system of claim 1, wherein said annotation includes the visual state of a graph displaying said graphical representation when said annotation is created.

3. The system of claim 1, wherein said annotation is indicated on graphs by a symbol or icon indicator artifact.

4. The system of claim 1 wherein said data source is energy consumption or generation measurements.

5. A method for directly associating an annotation and a graphical representation of set of data points on a computer system comprising:
1. displaying graphical data
2. indicating a range of graphical data
3. setting attributes and annotations that will be associated with said range
4. storing said attributes and annotations
5. retrieving said attributes and annotations
6. displaying when desired an indication of the existence of attributes and annotations when the associated data is displayed
7. displaying said attributes and annotations of a chosen set of data

6. The method of claim 5, wherein the display of said graphical data can duplicate the original display of said data when said annotation was created.

7. The method of claim 5, wherein the look of the indication of the existence of attributes and annotations on a graph is determined by the values of a set of the attributes and annotations.

8. The method of claim 5 wherein the data displayed is energy consumption or generation measurements.
